(19) United States
(12) Patent Application Publication
(10) Pub. No.: US 2023/0321578 A1
(43) Pub. Date: Oct. 12, 2023

(54) PARTICLE SEPARATOR FOR FLUIDS HAVING AN OUTLET CHAMBER ARRANGED WITHIN AN INLET CHAMBER AND FLUIDICALLY CONNECTED TO SAME

(71) Applicant: ESS Holding GmbH, Steyr (AT)

(72) Inventors: Alireza Eslamian, Steyr (AT); Martin Schifko, Steyr (AT)

(21) Appl. No.: 18/021,804

(22) PCT Filed: Aug. 23, 2021
(86) PCT No.: PCT/AT2021/060290

§ 371 Date: Feb. 16, 2023

(30) Foreign Application Priority Data
Aug. 21, 2020 (AT) A50706/2020

(51) Int. Cl. B04C 5/04; B01D 45/16; B04C 5/081; B04C 5/28; B04C 3/00

(52) U.S. Cl. CPC B01D 45/16; B04C 3/00; B04C 5/04; B04C 5/081; B04C 5/28

(57) ABSTRACT

A particle separator (1) for fluids has an outlet chamber (3) arranged within an inlet chamber (2) and is fluidically connected to same, wherein the inlet chamber (2) has a curved guide surface (5) extending around a main axis (4) running transverse to the main flow direction in the inlet chamber (2) for the fluid flowing into the inlet chamber (2) via an inlet channel (6). Particles can be filtered out of the fluid largely independently of the orientation of the particle separator relative to the gravitational vector and without entering the outlet channel even after separation of the fluid flow and possible positional change. The outlet chamber (3) is closed with respect to the inlet chamber (2) transverse to the direction of the main axis (4) and open in the direction of the main axis (4), and has an outlet channel (7) that extends through the inlet chamber (2).

### FIELD OF THE INVENTION

The invention relates to a particle separator for fluids having an outlet chamber arranged within an inlet chamber and fluidically connected thereto, wherein the inlet chamber has a curved guide surface extending around a main axis running transversely to the main flow direction in the inlet chamber for the fluid flowing into the inlet chamber via an inlet channel.

### DESCRIPTION OF THE PRIOR ART

Prior art particle separators for fluids are known in various embodiments. For example, WO2018175753A1 shows a cylindrical particle separator having an axis-parallel inlet and outlet, in which the fluid follows an arcuate flow direction in an inlet chamber. There, particles to be separated are forced to the outer edge of the inlet chamber due to centripetal force and decelerated, while the cleaned fluid escapes through an outlet chamber. The cylindrical outlet chamber is arranged inside the inlet chamber concentrically to the latter and is fluidically connected to the inlet chamber via an opening in the shell.

However, a disadvantage of the prior art is that particles are only effectively separated if the particle separator is correctly aligned relative to the gravity vector. If the aperture in the jacket chamber is not aligned parallel to the gravity vector, for example due to tilting of the particle separator, particles that have already been separated can pass from the inlet chamber into the outlet chamber, and thus into the purified fluid stream. The likelihood of such contamination increases, especially after the fluid stream has been interrupted, when centripetal forces are no longer acting. Although other prior art particle separators have collection vessels for the separated particles, these are subject to the same problems if sufficiently tilted.

### SUMMARY OF THE INVENTION

The invention is thus based on the object of designing a particle separator in such a way that particles can be filtered out of the fluid largely independently of the orientation of the particle separator relative to the gravitational vector and do not enter the outlet channel even after the fluid flow has been interrupted and its position possibly changed.

The invention solves the given object in that the outlet chamber is closed with respect to the inlet chamber transversely to the direction of the main axis and is open in the direction of the main axis. The part of the outlet chamber which is closed transversely to the direction of the main axis delimits with the guide surface of the inlet chamber the area in which the particles are separated from the fluid to be cleaned by means of centrifugal force and settle under the influence of gravity. This occurs independently of the spatial orientation of the particle separator with respect to the gravitational vector. If the outlet chamber is only open in the direction of the main axis, and is thus fluidically connected to the inlet chamber, in a preferred embodiment there is no continuous guide surface formed where the particles can leave the particle separator with the purified fluid under the influence of the gravitational force. This effect can be enhanced by spacing the opening of the outlet chamber from the guide surface of the inlet chamber. This drastically reduces the likelihood of deposited particles entering the outlet chamber, even when the particle separator is tilted after the fluid flow has stopped. The inlet channel can open into the inlet chamber either tangentially, arcuately or radially, depending on the application and requirements of the particle separator. Since the outlet chamber is preferably spaced on all sides from the guide surface of the inlet chamber, the outlet chamber must be appropriately supported within the inlet chamber. This can be carried out, for example, by supporting the outlet chamber via an outlet channel extending through the inlet chamber. The outlet chamber may be open to the inlet chamber in one or both directions of the main axis. Optionally, fluid guide bodies may be provided in the inlet chamber to deflect fluid into the outlet chamber. This can, for example, prevent local turbulence that increases flow resistance in the particle separator.

In order to achieve increased separation efficiency at the same inlet velocity of the fluid, the free cross-section of the inlet chamber bounded by the guide surface can decrease in the direction of the main axis. This leads to an increase in the flow velocity and thus in the acting centrifugal force proportional to the reduction in the free cross-section. This allows lighter particles to be separated without having to increase the inlet velocity of the fluid. In addition, this allows the separated particles to settle in a smaller, defined area, so that contamination can be further reduced. If the free cross-section is reduced by an inclination and/or curvature of the guide surface transverse to the main axis, the smaller free cross-section also reduces the maximum radius of the fluid flow circulating around the main axis and thus around the outlet chamber, so that not only the increased flow velocity but also the reduced radius leads to an increase in the centripetal force and thus the deposition rate. Depending on the direction of flow and the geometry of the inlet chamber, the cross-section bounded by the guide surface may decrease in at least one direction, or both directions, of the main axis.

In addition to the fluid velocity, the size of the particles to be separated can be selected with the curvature of the guide surface in a plane transverse to the main axis. In order to separate the particles as efficiently as possible, the inlet chamber can have a circular cross-section transverse to the main axis. As a result, the guide surface of the inlet chamber has the same curvature at every point in a plane transverse to the main axis, which keeps the centrifugal force acting on the particles to be separated constant. This enables uniform separation of particles of defined size and thus increases separation efficiency.

During operation, more and more separated particles accumulate in the particle separator, which, above a certain amount, can impair the fluid flow and/or the separation properties. In order to ensure unimpaired operation of the particle separator, especially during prolonged use, it is therefore proposed that the outer wall of the inlet chamber is pierced by a separation channel that is fluidically connected to the inlet chamber. Through the fluidically connected separation channel, a second fluid flow is created which, coming from the inlet channel, traverses the inlet chamber and leaves it through the separation channel. Separated particles that accumulate in the inlet chamber can enter this fluid stream without entering the outlet chamber and leave the particle separator with it via the separation channel. This further reduces the likelihood of contamination of the cleaned fluid stream. Depending on the application, the flow cross-section and the arrangement of the separation channel within the inlet chamber can be varied to allow optimal evacuation of separated particles. In a preferred embodiment, the separation channel extends parallel to the inlet channel or parallel to the cleaned fluid stream exiting the particle separator. If the outlet chamber is open to only one side, the separation channel can be arranged on the side of the inlet chamber opposite the opening of the outlet chamber. This allows a particularly compact arrangement of particle separators next to each other, which enables a space-saving design of filters.

For simplified support of the outlet chamber, it is proposed that the outlet chamber has an outlet channel extending through the inlet chamber. As a result of these measures, the outlet chamber can be supported within the inlet chamber via the outlet channel. As a result, the relative position of the inlet and outlet of the particle separator can be largely freely selected, with advantageous installation conditions resulting when the inlet and outlet are diametrically opposed with respect to the inlet and outlet chambers. This embodiment also favors an opening of the outlet chamber with respect to the inlet chamber in both directions of the main axis, if the outlet channel adjoins the outlet chamber on the jacket side.

To further reduce the entry of particles to be separated into the outlet channel, the outlet channel can extend transverse to the main axis. In the case of an outlet chamber extending in the direction of the main axis, this has the advantage that the fluid flow undergoes a change of direction when passing from the outlet chamber into the outlet channel, which any particles still present in the fluid flow cannot follow due to their inertia and thus do not reach the outlet channel.

Particles can be separated from the fluid even more efficiently if the fluid remains longer in the particle separator. In order to control the residence time with simple structural measures, the cross-section of the inlet channel can therefore exceed that of the outlet channel. This results in an increased flow resistance or a pressure buildup within the particle separator, which results in a longer residence time of the fluid in the particle separator.

To prevent particles from being carried from the inlet channel directly into the outlet channel, it is proposed that the inlet and outlet channels extend in a central plane transverse to the main axis. Since the outlet chamber is closed transverse to the direction of the main axis, it forms a physical barrier to particles to be separated in the fluid stream, thereby preventing them from entering the outlet channel directly or via possible turbulence.

The inlet and/or the outlet channel can extend in an arc around the inlet chamber, at least in sections.

The outlet chamber can be supported in the inlet chamber via the outlet channel. However, if, for example, the outlet channel is relatively small compared to the outlet chamber, or if the materials used are not sufficiently strong, further anchoring of the outlet chamber may be necessary. In order to increase the stability and durability of the particle separator without impairing its operation, it is proposed that the inlet chamber be separated into two half-chambers in the area of its largest free cross-section by a partition wall extending transversely to the main axis. This partition wall can, on the one hand, stiffen the entire particle separator by occurring external and internal forces and, on the other hand, form a loadable connection between the inlet and outlet chambers. In order to avoid contamination of the cleaned fluid flow in the outlet channel by already separated particles in this embodiment, it is proposed that the partition wall is pierced by the outlet chamber and thus does not pass through it. This allows particles introduced into the outlet chamber by gravity to pass through the outlet chamber back into the inlet chamber without the risk of the particles entering the outlet channel if the particle separator is tilted. In this case, the inlet and outlet channels can also be separated into two half-channels by the partition wall without impairing the operation of the particle separator. The partition wall can particularly preferably extend at the level of the central plane.

In order to ensure that the efficiency of the separation process does not change when the particle separator is tilted, or that particles of a different size are suddenly separated due to a change in position, it is proposed that the two half-chambers are designed symmetrically to the partition wall. In this way, the centrifugal forces acting in both half-chambers are kept at the same level, resulting in the same separation properties. Preferably, the outlet chamber can also be symmetrical in relation to the central plane or in relation to the partition wall.

In order to facilitate the assembly of the particle separators and to avoid contamination of the cleaned fluid stream with separated particles, a filter base can be provided which has an outlet in flow communication with the outlet chamber and which is spatially separated from a separation opening in flow communication with the separation channel. In a preferred embodiment, the filter base has two outer surfaces extending transversely to each other, one of which comprises the outlet and one of which comprises the separation opening.

In order to facilitate the manufacture of the particle separator by 3D printing and thus enable readily available series production, two structural elements can jointly form the inlet chamber. The particle separator thus comprises at least two components that can be joined together. Either both components or only one of the components can form the outlet chamber. An additional third component can form the filter base, which together with one of the other components can form the outlet channel.

The invention also relates to a filter with particle separators in which several particle separators are arranged side by side in a matrix, with the inlet channels opening into a common inlet side and the outlet channels opening into a common outlet side of the filter. This arrangement allows a high number of particle separators to be densely packed in the matrix of the filter and connected in parallel. If the inlet chambers are directly adjacent to each other and both the inlet and outlet channels are arranged parallel to each other, the packing density can be further increased. Such a filter can be used, for example, in a breathing mask or in the ventilation of a building. By using low-cost materials and production methods, such as injection molding, the filters can be disposed of as soon as the filter performance decreases due to the accumulated, separated particles within the particle separators. In the case of particle separators constructed from multiple components, a filter according to the invention may also be composed of at least two filter plates, wherein a filter plate comprises multiple components of the same type arranged in a matrix to form the particle separators.

To enable the separated particles of a filter to be easily collected together and, optionally, disposed of, it is proposed that the separation channels of adjacent particle separators open into at least one common separation opening for discharging the particles from the filter. In a preferred embodiment, the common separation opening is arranged on an outer side of the filter extending both transversely to the common inlet side and transversely to the common outlet side. Contamination of the cleaned fluid with separated particles is thus avoided.

### BRIEF DESCRIPTION OF THE INVENTION

The subject matter of the invention is shown in the drawings by way of example, wherein:

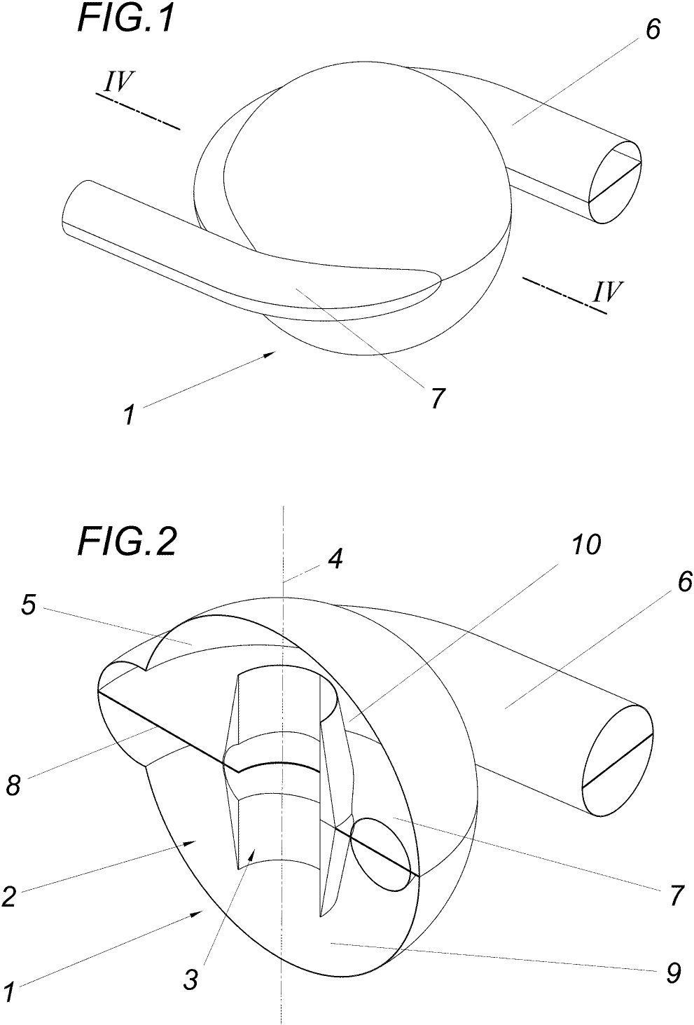

FIG. 1 shows a perspective view of a particle separator according to the invention,

FIG. 2 shows a perspective view of the particle separator exposed along line IV-IV of FIG. 1 at the same scale,

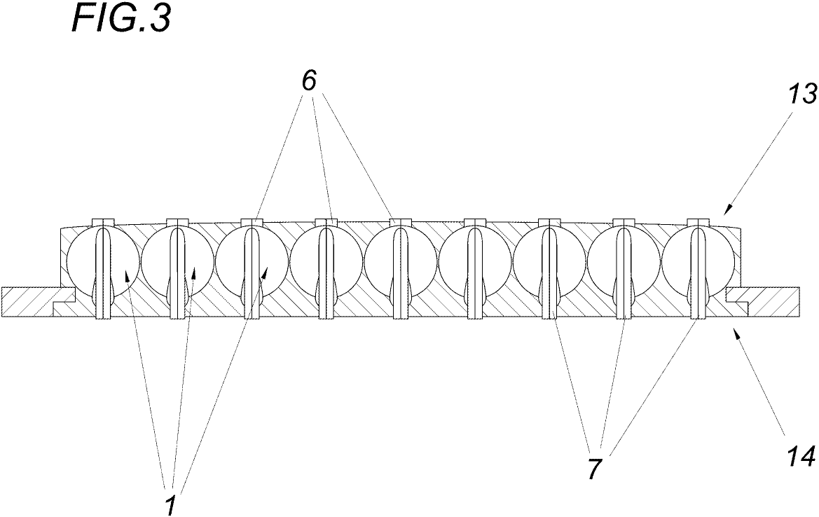

FIG. 3 shows a section through a filter with particle separators arranged next to each other in a matrix on a smaller scale,

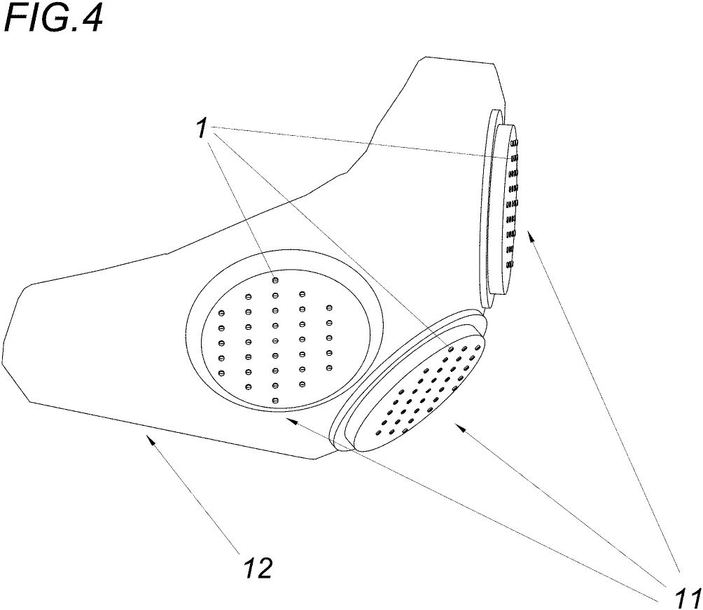

FIG. 4 shows a perspective view of a protective mask with having filters of FIG. 1 on an even smaller scale,

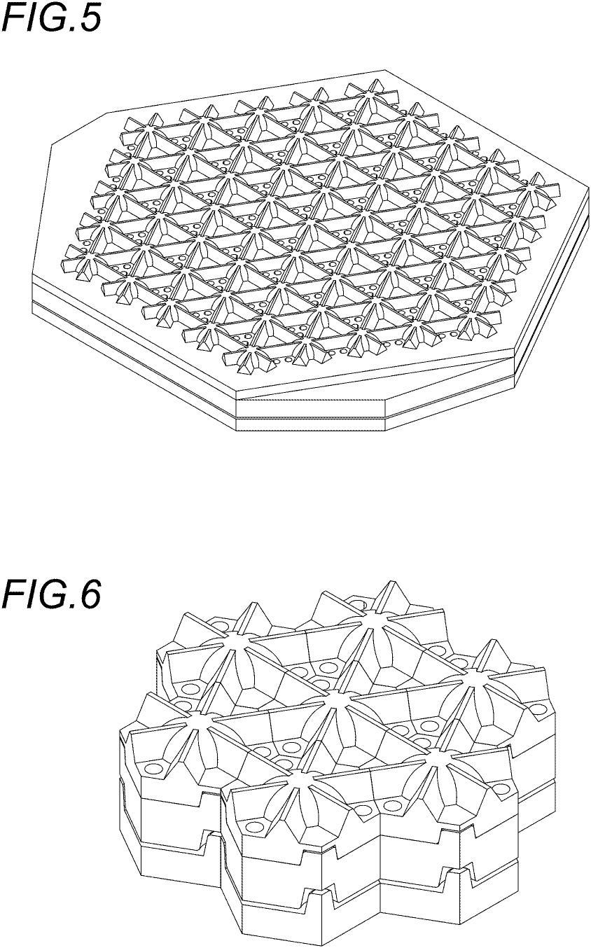

FIG. 5 shows a perspective view of a filter according to the invention in a second embodiment,

FIG. 6 shows an enlarged perspective view of several particle separators of the filter of FIG. 5 on a larger scale,

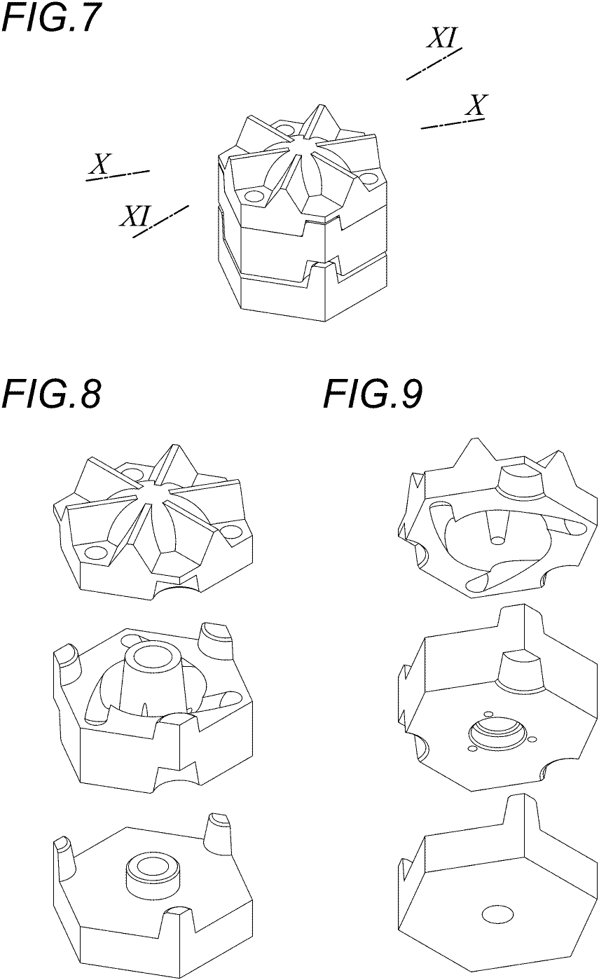

FIG. 7 shows a perspective view of a particle separator of FIG. 6,

FIG. 8 shows an exploded view of the particle separator of FIG. 7 from a first perspective,

FIG. 9 shows an exploded view of the particle separator of FIG. 7 from a second perspective,

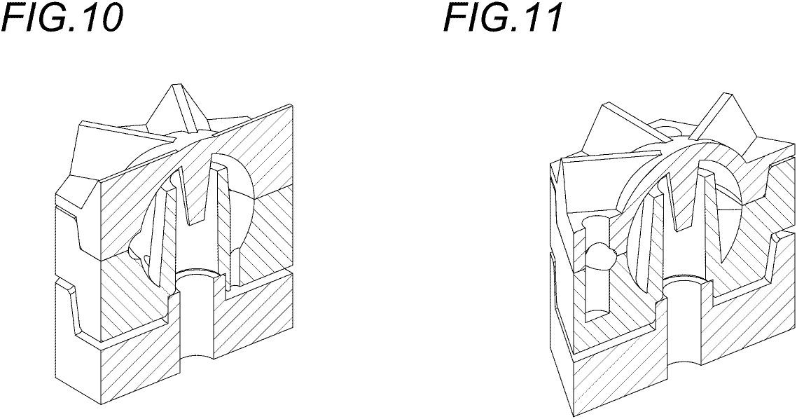

FIG. 10 shows a section along the line X-X of FIG. 7 on a larger scale, and

FIG. 11 shows a section corresponding to FIG. 10 along line XI-XI of FIG. 7.

### DETAILED DESCRIPTION OF THE PREFERRED EMBODIMENTS

A particle separator 1 according to the invention has an inlet chamber 2 and an outlet chamber 3 arranged inside the inlet chamber 2, which are fluidically connected to each other. The inlet chamber 2 comprises a guide surface 5 curved about a main axis 4 extending transversely to the main flow direction in the inlet chamber 2 for a fluid flowing into the inlet chamber 2 via an inlet channel 6. The inlet channel 6 opens into the inlet chamber 2 tangentially to the main axis 4. The outlet chamber 3 is closed with respect to the inlet chamber 2 transversely to the direction of the main axis 4 and open in the direction of the main axis 4 and has an outlet channel 7 extending through the inlet chamber 2, which preferably extends transversely to the main axis 4. Also, the diameter of the inlet channel 6 may exceed that of the outlet channel 7 to increase the residence time of the fluid in the particle separator 1. If both inlet channel 6 and outlet channel 7 lie in a central plane extending transversely to the main axis 4, it can be avoided that particles are conveyed from the inlet channel 6 directly into the outlet channel 7. As can be seen in particular from FIGS. 3 and 4, the inlet chamber 2 may have a circular cross-section transverse to the main axis 4 to achieve higher separation efficiency. Overall, the housing of the particle separator 1 may have substantially the basic shape of a sphere. For stiffening the particle separator 1 and as a loadable connection between inlet chamber 2 and outlet chamber 3, a partition wall 8 extending transversely to the main axis 4 may be provided, which separates the inlet chamber 2 in the region of its largest cross-section into two half-chambers 9, 10. In this case, these two half-chambers 9, 10 can preferably be formed symmetrically to the partition wall 8.

FIG. 3 shows a particularly preferred embodiment of the arrangement of the particle separators 1 in a filter, in which the inlet chambers 2 of the particle separators 1 are tightly packed next to each other in a matrix and all inlet channels 6 as well as all outlet channels 7 are arranged in parallel.

As can be seen from FIG. 4, the particle separators 1 can be arranged side by side in a matrix in a filter 11 of a mask 12, with the inlet channels 6 opening into a common inlet side 13 and the outlet channels 7 opening into a common outlet side 14 of the filter 11.

FIGS. 7, 8, 9 and 10 show a further embodiment of the particle separator 1, which comprise a separation channel 15 that breaks through the outer wall of the inlet chamber 2 forming the guide surface 5 and is fluidically connected to the inlet chamber 2. Thus, between the inlet channel 6 and the separation channel 15, a further fluid flow is formed through the inlet chamber 2, via which particles to be separated can be transported away from the particle separator. The particle separator 1 may further comprise a filter base 16, which is fluidically connected to the outlet chamber 3 and via which the cleaned fluid can be discharged from the particle separator 1. In the embodiment shown, the filter base 16 forms two transverse outer surfaces, one of which comprises an outlet 17 and one of which comprises a separation opening 18. In order to simplify the series production, as shown in this embodiment, the particulate filter 1 may be manufactured from at least two components 19, 20, which may be assembled after their separate manufacture. In this case, the filter base 16 can be designed as the third component.

FIGS. 5 and 6 show a further embodiment of a filter 11 according to the invention, which comprises several particle separators 1 built up from the components 19, 20 and the filter base 16. The components 19 of all particle separators 1 of the filter 11 are formed here from a filter plate 21. Similarly, all components 20 or all filter bases 16 of all particle separators 1 of the filter 11 are formed by the filter plate 22 or 23. The separated particles of several particle separators 1 of a filter 11 can be discharged via a common separation opening 24 on an outer side of the filter 11 extending both transversely to the common inlet side 13 and transversely to the common outlet side 14.

1. A particle separator for fluids, said particle separator comprising:
an outlet chamber arranged within an inlet chamber and fluidically connected thereto:
wherein the inlet chamber has a curved guide surface extending around a main axis running transversely to a main flow direction in the inlet chamber for the fluid flowing into the inlet chamber via an inlet channel; and
wherein the outlet chamber (3) is closed with respect to the inlet chamber transversely to the a direction of the main axis, and the outlet chamber is open in the direction of the main axis (4).

2. The particle separator according to claim 1, wherein a free cross-section of the inlet chamber bounded by the guide surface decreases in the direction of the main axis.

3. The particle separator according to claim 1, wherein the inlet chamber has a circular cross-section transverse to the main axis (4).

4. The particle separator according to claim 1, wherein the inlet chamber has an outer wall that is pierced by a separation channel that is fluidically connected to the inlet chamber.

5. The particle separator according to claim 1, wherein the outlet chamber has an outlet channel extending through the inlet chamber.

6. The particle separator according to claim 5, wherein the outlet channel extends transversely to the main axis.

7. The particle separator according to claim 1, wherein a cross-section of the inlet channel exceeds a cross-section of the outlet channel.

8. The particle separator according to claim 1, wherein the inlet channel (6) and the outlet channel run in a central plane extending transversely to the main axis (4).

9. The particle separator according to claim 1, wherein the inlet chamber is separated in the a region of its a largest free cross-section thereof into two half-chambers by a partition wall extending transversely to the main axis (4).

10. The particle separator according to claim 9, wherein the two half-chambers are symmetrical with respect to the partition wall.

11. The particle separator according to claim 4, and further comprising a filter base that has an outlet fluidically connected to the outlet chamber and spatially separated from a separation opening fluidically connected to the separation channel .

12. The particle separator according to claim 1, wherein the inlet chamber is formed by two components together.

13. A filter comprising:
a plurality of particle separators each according to claim 1,
wherein the plurality of particle separators are arranged side by side in a matrix; and
wherein the inlet channels of the plurality of particle separators open to a common inlet side of the filter, and the outlet channels open to a common outlet side of the filter.

14. The filter according to claim 13, wherein adjacent particle separators have respective separation channels that open into at least one common separation opening discharging the particles from the filter.

15. The particle separator according to claim 2, wherein the inlet chamber has a circular cross-section transverse to the main axis.

16. The particle separator according to claim 2, wherein the inlet chamber has an outer wall that is pierced by a separation channel that is fluidically connected to the inlet chamber.

17. The particle separator according to claim 3, wherein the inlet chamber has an outer wall that is pierced by a separation channel that is fluidically connected to the inlet chamber.

18. The particle separator according to claim 4, wherein the inlet chamber has an outer wall that is pierced by a separation channel that is fluidically connected to the inlet chamber.

19. The particle separator according to claim 15, wherein the inlet chamber has an outer wall that is pierced by a separation channel that is fluidically connected to the inlet chamber.
